(19) United States
(12) Patent Application Publication
(10) Pub. No.: US 2012/0187766 A1
(43) Pub. Date: Jul. 26, 2012

(54) Device and Method For Improving The Performance Of An Inverter In A Photovoltaic System

(75) Inventors: Thomas William CLELAND, Sharon (CA); Leszek MAC, Toronto (CA)

(73) Assignee: HYBRIDINE POWER ELECTRONICS INC., Sharon (CA)

(21) Appl. No.: 13/242,281

(22) Filed: Sep. 23, 2011

Related U.S. Application Data
(60) Provisional application No. 61/385,705, filed on Sep. 23, 2010.

(51) Int. Cl. H02J 1/00

(52) U.S. Cl. 307/82

(57) ABSTRACT

In one embodiment, a photovoltaic (PV) power generation system includes a plurality of PV arrays configured to convert received light into electricity, a double conversion device, wherein the double conversion device is coupled to the plurality of PV arrays, and an inverter, wherein the inverter is coupled to the double conversion device. In an exemplary embodiment, the double conversion device is a DC-DC converter.

### CROSS-REFERENCE TO RELATED APPLICATIONS

This application claims priority to U.S. Provisional Application No. 61/385,705 filed on Sep. 23, 2010.

### STATEMENT REGARDING FEDERALLY SPONSORED RESEARCH OR DEVELOPMENT

Not Applicable.

### THE NAMES OF PARTIES TO A JOINT RESEARCH AGREEMENT

Not Applicable.

### INCORPORATION-BY-REFERENCE OF MATERIAL SUBMITTED ON A COMPACT DISC.

Not Applicable.

### TECHNICAL FIELD

The present disclosure relates generally to a device and method for improving the performance of an inverter in a photovoltaic system.

### BACKGROUND

A photovoltaic system (or PV system) is a system that uses photovoltaic solar cells to convert light into electricity. A typical PV system generally consists of multiple components, including PV modules, and an inverter. Generally, the power that one PV cell can produce is seldom enough to meet requirements of a home or a business, so the PV cells are connected in series to obtain the desired voltage.

FIG. 1 illustrates the inner components of the PV inverter 100. As shown in FIG. 1, the inverter 100 includes a DC disconnect, a DC surge protection circuit, a unidirectional diode, a DC to AC converter, an isolation contactor, a control unit, an AC surge protection circuit, and an AC disconnect. It should be noted that the general operation of PV inverter 100 is explained below but this disclosure will not delve into the intricacies of the digital controls related to the inverter 100. Further there are many ancillary functions that this disclosure will not delve into, related to safety, protectionary (over-current), over voltage, frequency control and Anti-Islanding that are designed to shut off the output section of the inverter in certain instances, such as a short circuit or the loss of grid power, and thereby the inability of the grid to consume the power offered by the inverter.

The modern solid state Inverter itself is among other things, a digital controlled set of high power bi-polar transistors, that are configured in such a way, so that when output the transistor is (gated or biased) activated, the transistor (PNP) goes into saturation using an artificial analogue algorithm similar to a very high speed stepping circuit, that digitally forms the top half of a sine (0V-peak V-0V) wave, which must be completed in 8 milliseconds (based on 60 Hz operation), then another set of NPN transistors does the similar operation for the negative portion of the sine wave. These two operations are viewed on an oscilloscope as a full sine wave, and are completed 60 times per second (60 Hz).

Many PV power generation systems use the commercially available solid-state PV inverter 100 like the one illustrated in FIG. 1. For many years the commercially available solid-state PV inverter has taken a cherry picking approach to harvesting the DC energy produced by PV power generation systems. As a result there is a tremendous amount of energy produced by PV modules that the PV inverter never receives. In effect, the inverter is unable to convert this electricity into useable and stable AC electricity. In effect, this electricity generated by the PV modules is not harvested and is essentially wasted. It has been determined that this equates to about 50% of the energy being produced by the PV power generation system array is being wasted by the inverter's inability to not be able to harvest at low voltage and low current states.

One problems that modern and conventional PV inverters have is that the inverter system, at least the DC input side, has a very “limited” window of DC opportunity within which, there is enough latitude to produce an output sign wave of significant amplitude to meet the peak to peak voltage specifications and requirements of the connected load or often the grid.

In essence, and inarguably, there is a lot of available DC energy being generated by the PV panels below this standard threshold (early to mid-morning, at night, on cloudy days, and mid to late afternoon) that is generally ignored, because if a standard PV Inverter unit performs at this low voltage, the output voltage waveform may be adversely affected, (clipped because, there is not enough DC peak-to-peak latitude at the input to create a full sine wave at the output). In addition, if the PV inverter performs at this low voltage, the efficiency of conversion (DC-AC) at this low level of voltage and power, is also generally very inefficient, which is the case in all circumstances when an equipment operates at the lower (or higher) ends of its design parameters. So any power that may be available would be largely wasted due to inefficient conversion.

As will be explained with the aid of the drawings that follow, the present disclosure explains a method and device that minimizes the drawbacks associated with current PV inverters.

### BRIEF SUMMARY

Disclosed herein is a device and method for improving the performance of an inverter in a photovoltaic system. In one embodiment, a photovoltaic (PV) power generation system includes a plurality of PV arrays configured to convert received light into electricity, a double conversion device, wherein the double conversion device is coupled to the plurality of PV arrays, and an inverter, wherein the inverter is coupled to the double conversion device. In an exemplary embodiment, the double conversion device is a DC-DC converter.

### BRIEF DESCRIPTION OF THE DRAWINGS

These and other features, aspects, objects, and advantages of the embodiments described and claimed herein will become better understood upon consideration of the following detailed description, appended claims, and accompanying drawings where:

FIG. 1 is a schematic of a conventional PV inverter known in the prior art;

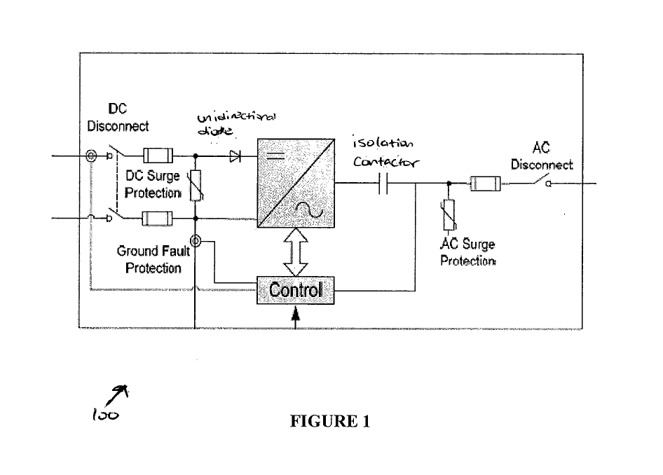

FIG. 2 is a block diagram of a PV power generation system 150;

FIG. 3 is a block diagram of the PV power generation system 150;

FIG. 4 is an output characteristic that compares output power of a conventional PV power generation system with that of PV power generation system disclosed herein; and

FIG. 5 is a flowchart of an exemplary method carried out by a double conversion device.

It should be understood that the drawings are not necessarily to scale and that the embodiments are sometimes illustrated by graphic symbols, phantom lines, diagrammatic representations and fragmentary views. In certain instances, details which are not necessary for an understanding of the embodiments described and claimed herein or which render other details difficult to perceive may have been omitted. It should be understood, of course, that the inventions described herein are not necessarily limited to the particular embodiments illustrated. Indeed, it is expected that persons of ordinary skill in the art may devise a number of alternative configurations that are similar and equivalent to the embodiments shown and described herein without departing from the spirit and scope of the claims.

Like reference numerals will be used to refer to like or similar parts from figure to figure in the following detailed description of the drawings.

### DETAILED DESCRIPTION OF THE DRAWINGS

Disclosed herein is a double power conversion device and method. In one embodiment, the double power conversion device (also referred to as the double conversion device or a two-step conversion inversion device) is positioned at the font end of a PV inversion system such that a two-step conversion inversion device is used, that uses conversion inversion technology (CIT).

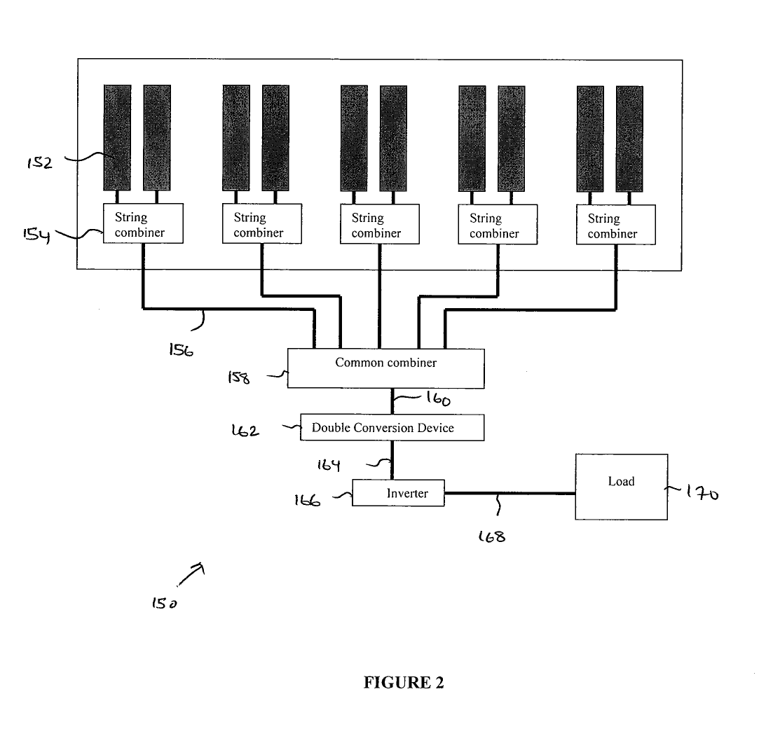

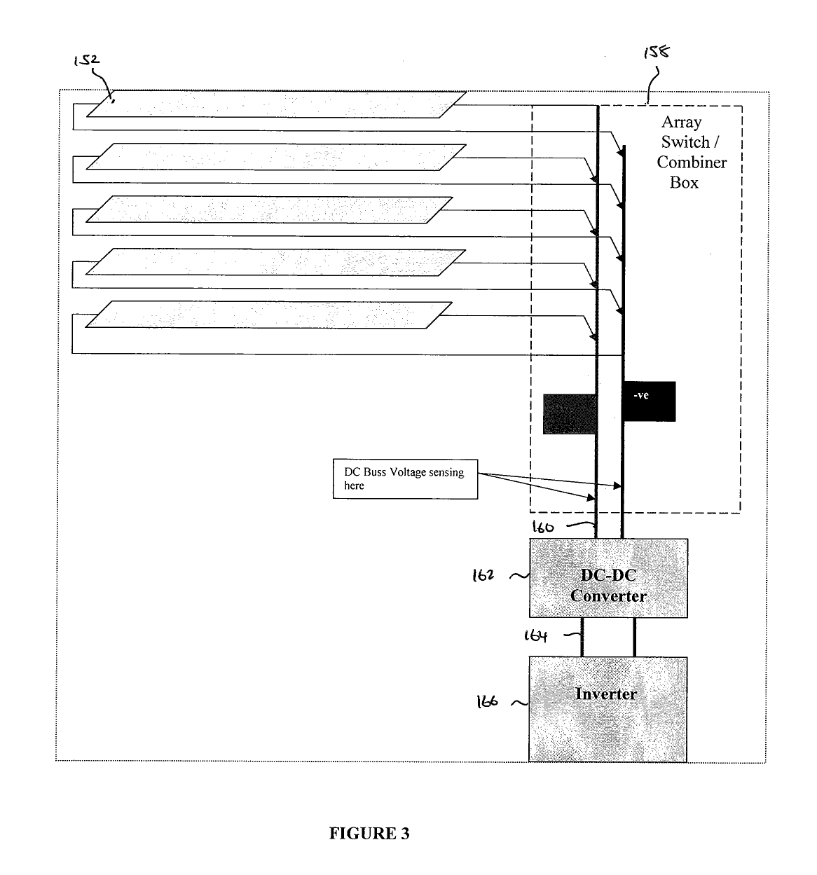

FIG. 2 illustrates an exemplary embodiment of a PV power generation system 150 (referred to as PV system 150). As shown in FIG. 3, the PV system 150 includes a plurality of PV strings 152, a plurality of string combiners 154, a plurality of DC links 156, a common combiner 158, a converter link 160, a double conversion device 162, an inverter link 164, a PV inverter 166, and a load link 168, and a load 170. FIG. 3 illustrates a detailed view of the PV system 150.

As shown in FIGS. 2 and 3, each of the components of the PV system 150 is coupled together via their respective links. For instance, the plurality of string combiners 154 are connected to the common combiner 158 via the DC links 156. The common combiner 158 is coupled to the double conversion device 162 via the converter link 160. The double conversion device 162 is in turn connected to the inverter 166 via the inverter link 164. And the inverter 166 is connected to the load via the load link 168.

In one embodiment, a PV array includes a plurality of PV strings and each PV string in each PV array in turn includes a plurality of PV panels (or PV modules) and each PV module or PV panel includes a plurality of PV solar cells. In one embodiment, the PV power system includes 42 PV arrays, wherein each PV array includes 2 PV strings, and each PV string includes 20 PV modules (i.e., PV panels), and each PV module/panel includes a plurality of solar cells.

The relative position of the double conversion device 162 should be noted. As shown in FIGS. 2 and 3, the double conversion device 162 is positioned between a DC source (i.e., the PV panels, PV modules, or PV strings) and the inverter 166. In particular, the double conversion device 162 is placed in-line (series) downstream of the output of the PV arrays (or PV modules), and upstream of the inverter 166 input, assuming the current is traveling from the panels to the inverter.

In this regard, instead of connecting the DC power output of the PV panel system directly to the input of an inverter (as in conventional PV power systems), the double conversion device 162 is positioned between the DC power source and the inverter 166, where an input of the double conversion device 162 is coupled to an output of the common combiner 158 and an output of the double conversion device 162 is coupled to an input of the inverter 166 The double conversion device 162 generally operates to increase the low voltage low current power from a low level to higher voltage level at which the PV inverter 166 recognizes that a higher voltage that is within its nominal operating range is being presented to it.

In one embodiment, the double conversion device 162 is a sold state DC-DC conversion device (i.e., a DC-DC converter). In this embodiment, the solid state DC-DC converter is configured to increase the low voltage low current power, from a low level to higher level at which the PV inverter 166 recognizes that the higher voltage (albeit at lower current) power being presented to it is within the its nominal operating range.

In an exemplary embodiment, the low voltage low current power starts between 80-100VDC, which is the typical output of the DC source (i.e., the PV panels) at low light levels. The higher voltage after the increase is about 450 volts (albeit a lower current power). At this higher voltage, the PV inverter recognizes it as being within it's nominal operational range to convert from DC to AC efficiently.

Adding a double conversion device 162 between the DC source and the PV inverter 166 is essentially an added step in the overall electrical generation process. This device (i.e., the double conversion device 162), from an electrical standpoint, is invisible to the PV inverter 166 section. The double conversion device 162 simply looks like a stable current source with an output voltage available that is within an operational range or an operational window of the PV inverter 166.

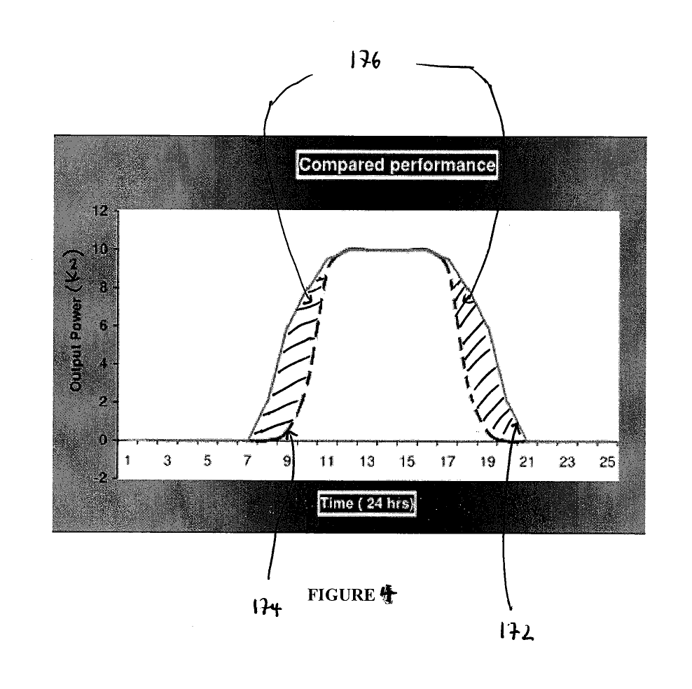

FIG. 4 is an output characteristic that compares output power of a conventional PV power generation system with the output power of the PV power generation system 150 disclosed herein. Dotted line 174 represents the output power from a PV inverter in a conventional power generation system that does not use an converter coupled to the PV inverter. Solid line 172 represents the output power of a PV inverter in the PV system 150, where the PV inverter is coupled to DC-DC converter. The shaded area represents the increased annual power output in Kw-hrs per day. In one embodiment, the shaded area represents a 30%-40% increase in the annual power output in Kw-hrs per day.

In one embodiment, the PV inverter has an operational range or an operational window of 250VDC-600VDC. And in an exemplary embodiment, the double conversion device 162 has an operational window of 70VDC-450VDC. In this embodiment, a DC-DC converter of this operational range may be used to match ratings for implementations in North America. In another exemplary embodiment, the double conversion device 162 has an operational window of 70VDC-600VDC. In this embodiment, a converter of this operational range may be used to match the ratings for implementations in Europe. From a power capability standpoint only need be 25-30% rated, as compared to the full-load rated capability of the PV array and matched Inverter system. This is because the power available (up to 50% of the Inverter's rating), pre and post the standard inverter's power window cannot be 100% harvested with existing Solid State technology, therefore assuming some losses a 25-30% rating is appropriate.

In some embodiments, it is fundamentally advantageous to have feedback from the inverter itself in terms of utilizing the best methods of controlling the power provided by the double conversion device 162 to the inverter 166. In this regard, in one embodiment, the double conversion device 162 receives feedback from the PV inverter 166.

An input sensing system on the DC-DC converter performs Maximum Power Point Tracking (MPPT), current and voltage availability tests controlled by a dedicated micro processor, using a custom “Expert System” Software on the PV array, similar in operation and logic to those the commercial inverter as a single step process would perform, except that the output of the DC-DC converter is “0”VDC until such times as the expert system has determined that there is enough “power” (V×I=P) available to provide 450VDC at a reasonable current to the input of the second stage, which is the commercial inverter.

As noted above, the PV inverter 166 typically waits to provide power to a load until the input DC voltage reaches a certain threshold. For instance, in the morning as the sun rises, the PV inverter waits until the DC voltage provided to reaches a certain threshold. Once the threshold is reached, the PV inverter 166 applies the solid state transistor equivalent of a linear resistive load across the positive lead with respect to negative leads to test the current production. In doing so, the PV Inverter tests the power (Voltage×Current=Power) producing capability of the DC power source (in this case the PV modules or PV panels). This is done very rapidly in ever increasing increments to the point where the voltage drops off in relation to the increase in current.

At the point where this is a stable function, DC energy is allowed to flow to the next section in the process, which is the actual inverter. The inverter chops and disseminates the DC current into an analogue synthetic reconstruction (approximation) or a Sine wave. The algorithms that carry out this power testing and tracking procedure are called Maximum Power Point Tracking (MPPT) algorithms, are generally programmed into and managed by a micro processor.

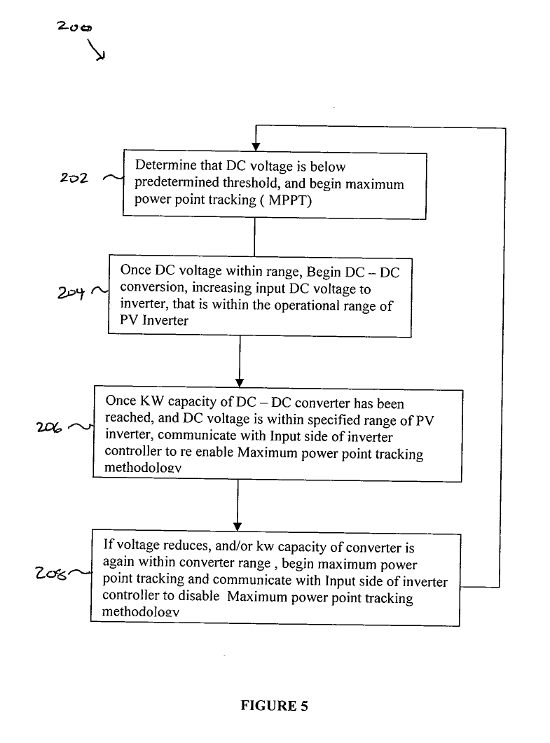

FIG. 5 is a flowchart of an exemplary method 200 carried out by the double conversion device 162. At block 202 the double conversion device 162 determines that an input DC voltage from the at least one PV device is below predetermined threshold/value. In response to that determination, the double conversion device begins maximum power point tracking (MPPT).

At block 204, the double conversion device 162 determines that the input DC voltage at the double conversion device 162 is within a first predetermined range. In one embodiment, the first predetermined range is an operational range of the double conversion device 162. In response to that determination, the double conversion device 162 increases the output DC voltage of the double conversion device 162 (i.e., input to the PV inverter 166).

At block 206, once the power capacity of the double conversion device 162 is reached, and the DC voltage is within a second predetermined range, the double conversion device 162 communicates with an input of the PV inverter 166 to re-enable maximum power point tracking methodology. In one embodiment, the second range is an operational range of the PV inverter 166.

At block 208, if the voltage reduces, and/or power capacity (or kilowatt capacity) of the double conversion device is again within an operational range of the double conversion device 162, the double conversion device 162 begins maximum power point tracking and communicates with an input side of an inverter 166 to disable maximum power point tracking methodology. The method 200 continues to block 202, where the double conversion device 162 continues to determine whether an input DC voltage from the at least one PV device is below predetermined threshold/value.

In one embodiment, the PV device serves as a DC power source. And the PV device is a PV array. In another embodiment, the PV device is a PV module. And in yet another embodiment, the PV device is a PV string.

The double conversion device 162, in another embodiment, carries out another method. In particular, double conversion device 162 determines that an input DC voltage from at least one PV device is below a predetermined value. The double conversion device 162 determines that the input DC voltage is increasing or decreasing. In response to this determination, the double conversion device adjusts the input DC voltage to an output DC voltage that matches or is within an operational range of the PV inverter.

Although the device and method for improving the performance of an inverter in a photovoltaic system described herein have been described in considerable detail with reference to certain embodiments, one skilled in the art will appreciate that the device and method for improving the performance of an inverter in a photovoltaic system described and claimed herein can be practiced by other than those embodiments, which have been presented for purposes of illustration and not of limitation. Therefore, the spirit and scope of the appended claims should not be limited to the description of the embodiments contained herein.

We claim:

1. A photovoltaic (PV) power system comprising:
a plurality of PV devices configured to convert received light into electricity;
a double conversion device, wherein the double conversion device is coupled to the plurality of PV devices; and
an inverter, wherein the inverter is coupled to the double conversion device.

2. The PV power system of claim 1, further comprising a load, wherein the load is coupled to the inverter.

3. The PV power system of claim 1, wherein the PV devices are selected from the group consisting of PV arrays, PV strings, and PV modules.

4. The PV power system of claim 1, wherein the double conversion device comprises a DC to DC converter.

5. The PV power system of claim 1, wherein the double conversion device comprises a current source.

6. The PV power system of claim 1, wherein the double conversion device has an operational range of 70VDC-450VDC.

7. The PV power system of claim 1, wherein the double conversion device has an operational range of 70VDC-600VDC.

8. The PV power system of claim 1, wherein the PV inverter has an operational range of 250VDC-600VDC.

9. The PV power system of claim 1, wherein the double conversion device has an input portion and output portion, wherein the input portion is coupled to an output of the plurality of PV devices, and wherein the output portion is coupled to an input of the PV inverter.

10. The PV power system of claim 1, wherein an output of the inverter is coupled to both a load and to an input of the double conversion device, wherein the connection between the double conversion device and an output of the inverter is configured to provide feedback data to the double conversion device.

11. A photovoltaic (PV) power system comprising:
a plurality of PV devices configured to convert received light into electricity;
a DC to DC converter, wherein the DC-DC converter device coupled to the plurality of PV arrays; and
an inverter, wherein the inverter is coupled to the DC-DC converter.

12. The PV power system of claim 9, wherein the converter device comprises a current source.

13. A DC-DC converter comprising:
an input portion, wherein the input portion is coupled a plurality of PV devices; and
an output portion, wherein the output portion is coupled an inverter.

14. A method comprising:
determining that an input DC voltage from at least one PV device is below a predetermined value;
in response to the determination, increasing the input DC voltage to a first DC voltage within a predetermined voltage range, wherein the predetermined voltage range is an operational range of a PV inverter.

15. The method of claim 14, further comprising:
prior to determining that an input DC voltage from at least one PV device is below a predetermined value, receiving an input DC voltage from at least one DC power source, wherein the at least one DC power source comprises the least one PV device.

16. The method of claim 15, wherein the at least one PV device is selected from the selected from the group consisting of a PV array, a PV string, and a PV module.
